(19) United States
(12) Patent Application Publication
(10) Pub. No.: US 2011/0147402 A1
(43) Pub. Date: Jun. 23, 2011

(54) METHOD OF DISPENSING PRODUCTS OFF A VENDING MACHINE TRAY

(76) Inventor: Gabriele Valota, Dalmine (IT)

(21) Appl. No.: 12/992,547

(22) PCT Filed: May 14, 2009
(86) PCT No.: PCT/IB2009/005598

§ 371 Date: Mar. 8, 2011

(30) Foreign Application Priority Data
May 15, 2008 (IT) TO2008A000364

(51) Int. Cl. G07F 11/42; B65G 59/00

(52) U.S. Cl. 221/1

(57) ABSTRACT

In a vending machine, in which products are arranged on a tray and are movable along the tray, by a conveyor device, towards an outlet controlled by a release device movable between a closed position and an open position, the conveyor device is reversed, after one product is dispensed and before and during closure of the release device, to detach the remaining products from the release device.

### TECHNICAL FIELD

The present invention relates to a method of dispensing products off a vending machine tray.

### BACKGROUND ART

Product vending machines are known to comprise a cabinet or similar container defining a compartment, which is closed at the front by a door and houses a number of fixed, superimposed trays supporting respective numbers of products, e.g. bottles or cans. The trays occupy a rear portion of the compartment, so as to define, between the door and their front ends facing the door, a drop shaft communicating with a pickup compartment normally housed in the bottom of the cabinet.

The products on each tray are arranged in lines, perpendicular to the door, on respective powered conveyor belts, each of which is operated selectively by the user to feed the respective line of products to a respective release device for releasing the products one at a time into the drop shaft.

The release device normally comprises a powered gate defined by one or two swing flaps, and which is activated, when the belt is moving, to move between a closed position, in which the flap/s prevent the moving conveyor from dropping the products off the tray, and an open position, in which the flap/s are interposed between the first and second product in the relative line, so as to only allow the first product in the line to drop off the tray.

After the gate is moved back into the closed position, the belt is kept moving long enough to move the first product in the line into position contacting the gate and ready for the next release operation.

The flap/s forming the gate are normally opened by an electromagnetic actuator and closed by a return spring.

Though effective and straightforward, the above method has the drawback of being relatively energy-intensive to operate the electromagnetic actuator. That is, since the flaps close in opposition to the pressure exerted on them by the relative line pushed forward by the belt; a fairly robust return spring is required, which means a relatively high-power electromagnetic actuator is needed to overcome the effect of the return spring when opening the flaps.

### DISCLOSURE OF INVENTION

It is an object of the present invention to provide a method of dispensing products off a vending machine tray, designed to eliminate the above drawback.

According to the present invention, there is provided a method of dispensing products off a vending machine tray, as claimed in claim 1 and preferably in any one of the following Claims depending directly or indirectly on claim 1.

### BRIEF DESCRIPTION OF THE DRAWINGS

A non-limiting embodiment of the present invention will be described by way of example with reference to the accompanying drawings, in which:

FIG. 1 shows a schematic view in perspective of a vending machine implementing the method according to the present invention;

FIGS. 2 to 4 show plan views of a FIG. 1 detail in respective different operating configurations;

FIGS. 5 and 6 show larger-scale details, with parts removed for clarity, of FIGS. 2 and 3 respectively;

FIGS. 7 and 8 show larger-scale views, with parts removed for clarity, of a FIG. 1 detail in respective different operating configurations.

### BEST MODE FOR CARRYING OUT THE INVENTION

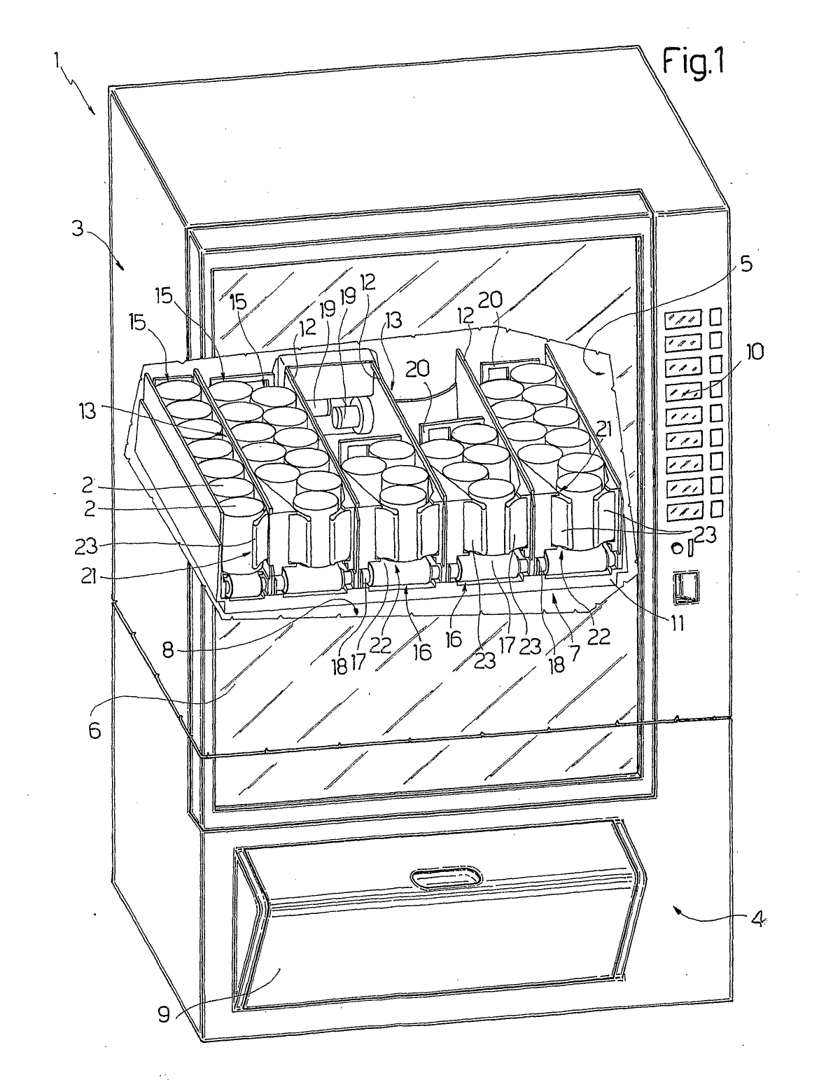

Number 1 in FIG. 1 indicates as a whole a vending machine for products, 2, comprising a cabinet 3 having a wall 4, which defines the front of an inner compartment 5 and is in turn defined partly by a door 6 made at least partly of transparent material.

Inside compartment 5, facing door 6, machine 1 houses a number of superimposed trays 7 (only one shown in FIG. 1) which support products 2, extend in respective substantially horizontal planes crosswise to wall 4, and occupy a rear portion of compartment 5, so as to define, between door 6 and their respective front ends facing door 6, a drop shaft 8 communicating with a pickup drawer 9 located beneath door 6 and from which to withdraw from the outside a product 2 selected beforehand on a pushbutton panel 10 on wall 4 and dispensed from one of trays 7 as described in detail below.

With reference to FIG. 1, each tray 7 comprises a frame defined by a substantially horizontal base 11, and by a number of partitions 12, which are perpendicular to base 11 and wall 4, and divide tray 7 into five channels 13 extending along respective axes 14 perpendicular to wall 4, and housing products 2—in the example shown, cans—arranged in lines 15 parallel to axes 14.

More specifically, depending on how wide they are, channels 13 each house one line 15 (in which case, channel 13 is referred to hereinafter as a “one-line” channel), or, to increase the capacity of tray 7, two parallel or offset lines 15 (in which case, channel 13 is referred to hereinafter as a “two-line” channel).

The bottom wall of each channel 13 is defined by a respective belt conveyor 16 comprising a belt 17 looped about two rollers 18, which are located at the ends of relative channel 13, extend crosswise to partitions 12, and define, on belt 17, a top branch, parallel to relative axis 14, for supporting and conveying relative products 2.

Conveyors 16 of each tray 7 are powered by two reversible electric motors 19 located at the rear end of relative tray 7 and connected to a central control unit (not shown).

More specifically, one of the two motors 19 of each tray 7 powers three of the five conveyors 16, and the other motor 19 powers the other two conveyors 16. Other embodiments, not shown, may obviously comprise more than two motors 19, and each conveyor 16 may even be equipped with its own motor 19. Similarly, in other embodiments not shown, each tray 7 may differ from the tray 7 in the example shown, as regards both the number and width of channels 13.

Each channel 13 has a known support 20 at the rear of relative line 15 to prevent products 2 from toppling over as relative belt 17 moves forward, or in the event of violent shaking of machine 1, e.g. by vandals.

At the end facing door 6, each channel 13 communicates with drop shaft 8 through an opening 21 defined by the free ends of partitions 12 defining channel 13, and which is controlled by a respective release device 22 for selectively releasing products 2 and which, in use, is activated, upon operation of relative conveyor 16, to only allow one product 2 at a time to drop into drop shaft 8.

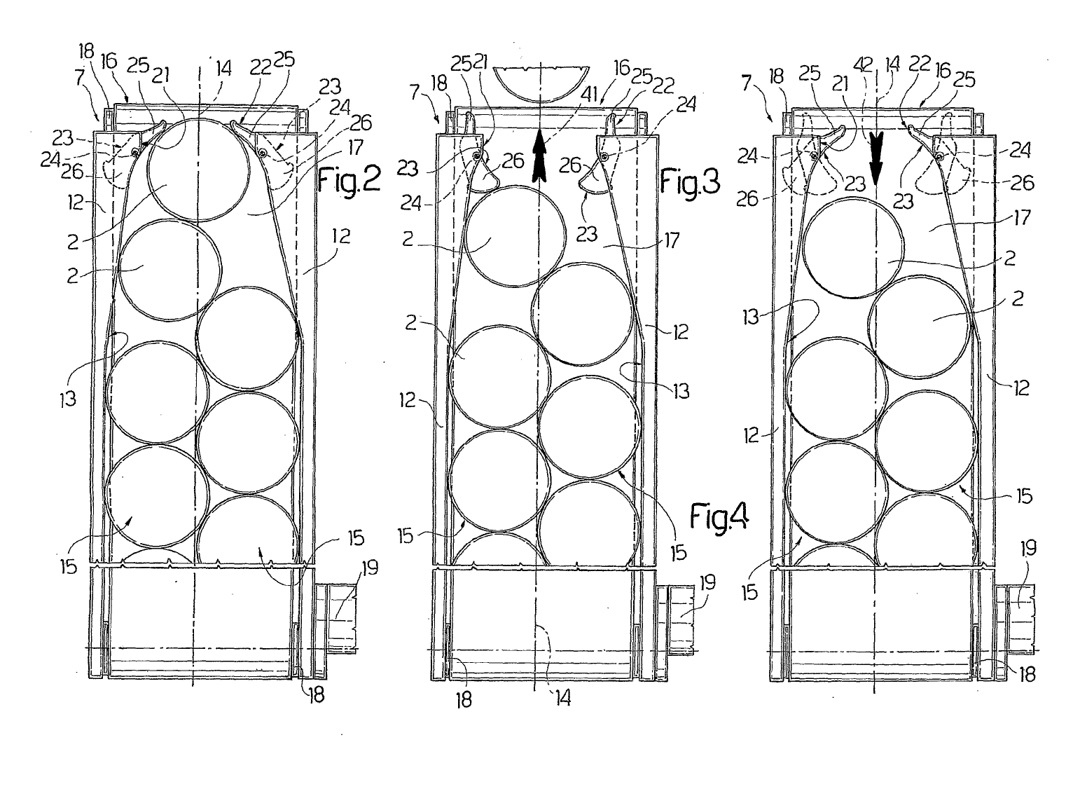

With reference to FIG. 2, close to relative opening 21, partitions 12 of each two-line channel 13 have respective thickened portions defining, in channel 13, a funnel tapering towards opening 21 to reduce the two lines 15 to one line and so feed one product 2 at a time to opening 21.

As shown in FIG. 1, release devices 22 of two-line channels 13 each comprise two flaps 23, each hinged to a respective partition 12 to rotate about a respective axis 24 perpendicular to base 11. Release device 22 of one-line channel 13, on the other hand, comprises one flap 23 identical to flaps 23 of two-line channels 13 and hinged to the partition 12 separating the one-line channel 13 from the adjacent channel 13 to rotate about a respective axis 24 perpendicular to base 11.

As shown in FIGS. 2 to 4, which refer to any one of the two-line channels 13, each flap 23 is defined by a curved member positioned with its concavity facing axis 14, and comprising a front portion 25, which extends outwards of channel 13 from respective axis 24 and towards drop shaft 8; and a rear portion 26, which extends from axis 24 in the opposite direction to front portion 25.

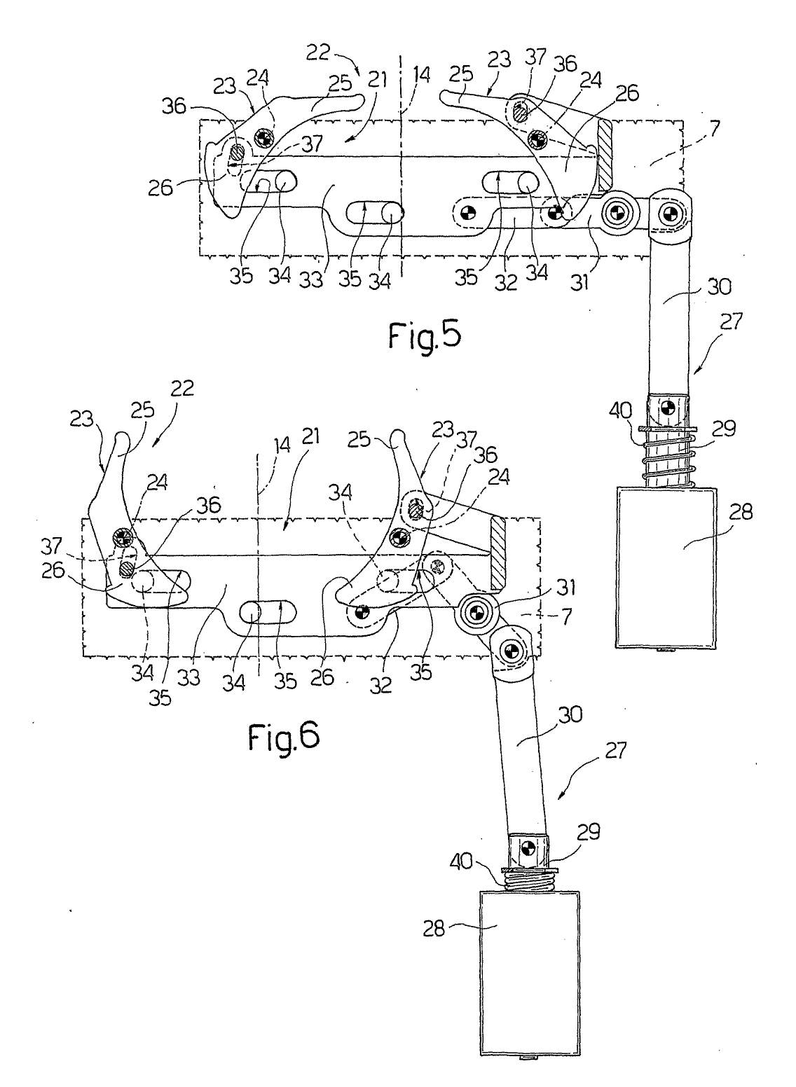

Flaps 23 are mounted to swing about respective axes 24 between a closed position (FIGS. 2 and 5), in which each front portion 25 is inclined towards axis 14 and towards the other front portion 25 to partly close opening 21 and hold back the products 2 fed forward on belt 17, and an open position (FIGS. 3 and 6), in which front portions 25 are substantially parallel to each other and to axis 14, and each rear portion 26 is inclined towards axis 14 and towards the other rear portion 26 to partly close opening 21 and hold back the products 2 fed forward on belt 17.

Flaps 23 of each release device 22 are moved to and from the closed position by a relative actuating device 27, which forms part of release device 22 and is connected to said central control unit (not shown).

Actuating device 27 of each two-line channel 13 comprises (as shown in FIGS. 5 and 6) an electromagnet having an output core 29 movable axially, in a direction parallel to axes 14, between a normal extracted position (FIG. 5) corresponding to the closed position of flaps 23, and a withdrawn position (FIG. 6) corresponding to the open position of flaps 23.

Motion is transmitted between core 29 and flaps 23 by a mechanical transmission comprising a connecting rod 30, which extends substantially parallel to axis 14 and is hinged to core 29 to oscillate about an axis parallel to axes 24; and a rocker arm 31, which is hinged to tray 7 to oscillate about a fixed axis parallel to axes 24, and comprises two opposite arms hinged respectively, by respective pins parallel to axes 24, to the free end of connecting rod 30, and to one end of a lever 32, the opposite free end of which is hinged to a bracket 33 for activating flaps 23.

More specifically, bracket 33 is fitted to tray 7 by three pins 34 integral with base 11 and engaging respective slots 35, which are formed through bracket 33, extend crosswise to axis 14, and define, with pins 34, a straight guide that forces bracket 33, when moved by lever 32, to move in a direction perpendicular to axis 14.

Bracket 33 is connected to flaps 23 by two pins 36 fitted to flaps 23 and which slide transversely inside respective slots 37, formed in the ends of bracket 33, to convert the translatory movement of bracket 33 to rotation of flaps 23 in opposite directions about respective axes 24.

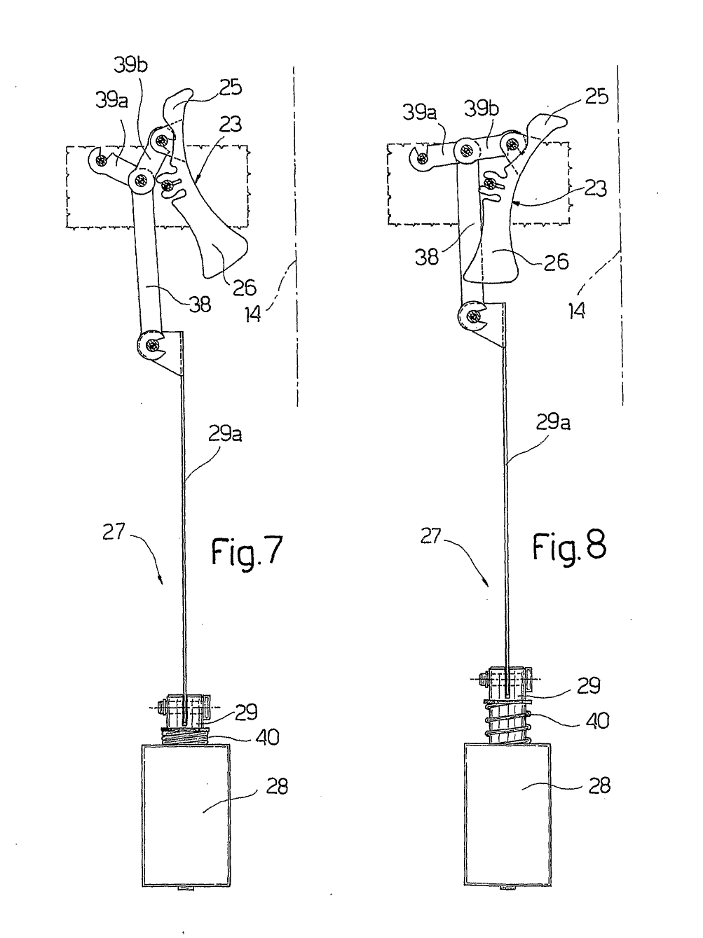

In addition to electromagnet 28 and core 29, actuating device 27 of each one-line channel 13 (FIGS. 7 and 8) comprises a mechanical transmission, in turn comprising a bar 29a projecting from and hinged to core 29 to oscillate about an axis perpendicular to core 29; and a connecting rod 38 hinged to the free end of bar 29a to oscillate about an axis parallel to axis 24. At the opposite end, connecting rod 38 is hinged to a movable pin parallel to axis 24 and which defines a pivot between two levers 39a and 39b; the free end of lever 39a is hinged to a fixed pin parallel to axis 24; and the free end of lever 39b is hinged to front portion 25 of flap 23 to rotate flap 23, in use, about axis 24.

In the case of both one-line and two-line channels 13, when electromagnet 28 is energized, core 29 is moved, in opposition to a spring 40 coiled about core 29, from the extracted position (FIGS. 5 and 8) corresponding to the closed position of flap/s 23, to the withdrawn position (FIGS. 6 and 7), thus moving flap/s 23 into the open position by means of the mechanical transmission described above.

The method of dispensing a product 2 off relative tray 7 will now be described with reference to FIGS. 2 to 4, which relate to a two-line channel 13. The same method, of course, also applies to products 2 in one-line channel 13.

At rest, conveyor 16 of channel 13 is stationary, and relative release device 22 is in the closed position with the first product 2 in line 15 located between flaps 23 and resting against respective front portions 25.

When a product 2 is selected by the user, the central control unit (not shown) activates motor 19 connected to conveyor 16, and belt 17 starts sliding beneath products 2 in a dispensing direction 41 parallel to axis 14 and towards drop shaft 8.

As soon as belt 17 is started, the central control unit (not shown) operates actuating device 27 to move flaps 23 from the closed to the open position (FIG. 3). During this movement, the first product 2 in line 15 is expelled through opening 21 by the forward movement of belt 17, and the next product 2 in line is stopped by rear portions 26 and pushed against rear portions 26 by the rest of line 15 moved forward by belt 17.

Once the product is, dispensed, the central control unit (not shown) reverses motor 19 to move products 2, by means of belt 17, in a reverse direction 42 opposite dispensing direction 41.

As soon as belt 17 starts moving backwards, and the first product 2 in line 15 is detached from rear portions 26 (dash line in FIG. 4), the central control unit (not shown) cuts off electric power to electromagnet 28, so flaps 23 are restored by spring 40 to the closed position (continuous line in FIG. 4).

At this point, motor 19 is immediately reversed again, and belt 17 is moved in dispensing direction 41 long enough to move the first product 2 onto front portions 25 (FIG. 2).

By inverting belt 17 and eliminating the pressure exerted by line 15 on rear portions 26 of the open flaps 23, flaps 23 can therefore be closed using a relatively weak return spring 40, so the energy supplied to electromagnet 28 may be equally reduced to open flaps 23 in opposition to spring 40.

1. A method of dispensing products (2) off a tray (7) of a vending machine (1), in which the products (2) are movable along the tray (7), by conveying means (16), towards an outlet (21) controlled by release means (22) movable between a closed position and an open position; the method comprising, after a step of dispensing one product (2) and before and during a subsequent step of closing the release means (22), a step of reversing the conveying means (16) to detach the remaining products (2) from the release means (22).

2. A method as claimed in claim 1, and comprising the steps of:
placing the products (2) on the tray (7) and in engagement with the conveying means (16);
activating the conveying means (16) to feed the products (2) in a dispensing direction (41) towards the outlet (21) and towards the release means (22) in the closed position;
moving the release means (22) into the open position, while keeping the conveying means (16) moving, so as to dispense one product (2) off the tray (7) by means of the conveying means (16), and also retain the remaining products (2) on the tray (7);
moving the release means (22) back into the closed position;
reversing the conveying means (16), after the dispensing step and before and during the step of closing the release means (22), so as to move said remaining products (2) in a reverse direction (42) away from the release means (22).

3. A method as claimed in claim 2, and comprising, after the step of closing the release means (22), the further step of activating the conveying means (16) to move said remaining products (2) in the dispensing direction (41) towards the release means (22) in the closed position.

4. A method as claimed in claim 1, wherein the conveying means (16) are moved by reversible electric actuating means (19).

5. A method as claimed in claim 1, wherein the tray (7) is housed in a compartment (5) of the vending machine (1) closed at the front by a door (6); the dispensing direction (41) being substantially perpendicular to said door (6) and towards the door (6).

6. A method as claimed in claim 2, wherein the conveying means (16) comprise at least one conveyor belt (17); the products (2) on the tray (7) being placed resting on the belt (17), and being moved by the belt (17) in said dispensing and reverse directions (41, 42).

7. A method as claimed in claim 6, wherein the products (2) are arranged on the belt (17) in at least one line (15) substantially parallel to the dispensing direction (41).

8. A method as claimed in claim 1, wherein the release means (22) are moved from the closed position to the open position by an electromagnetic actuating device (28), and are restored to the closed position by a return spring (40).
